(19) United States
(12) Patent Application Publication
(10) Pub. No.: US 2010/0163718 A1
(43) Pub. Date: Jul. 1, 2010

(54) METHOD AND APPARATUS FOR INCREASING THE EFFICIENCY OF A FLUORESCENCE MEASUREMENT CELL

(75) Inventors: Peter SCHAEFER, Grob Kreutz BRB (DE); Stefan SROKA, Adelheidsdorf (DE); Tobias KISCHKAT, Celle (DE)

Correspondence Address: CANTOR COLBURN LLP- BAKER HUGHES INCORPORATED, 20 Church Street, 22nd Floor, Hartford, CT, 06103, US

(73) Assignee: BAKER HUGHES INCORPORATED, Houston, TX (US)

(21) Appl. No.: 12/346,037

(22) Filed: Dec. 30, 2008

(51) Int. Cl. G01V 8/10; G01J 3/40

(52) U.S. Cl. 250/269.1; 356/317

(57) ABSTRACT

An apparatus for estimating a property of a fluid in an earth formation, the apparatus including: a logging instrument configured to be conveyed in a borehole penetrating the formation; and a plurality of light sources disposed at the logging instrument; wherein each of the light sources is configured to illuminate a sample of the fluid with a light beam causing the sample to fluoresce light with a characteristic related to the property, each of the light sources being configured to provide a light beam with a solid angle and a distance traveled to the sample, the solid angle and the distance being configured to concentrate the beam at an area of the sample that is overlapped substantially a same amount by a beam from another light source in the plurality.

### BACKGROUND OF THE INVENTION

1. Field of the Invention

The present invention relates to apparatus and method for measuring a property of a fluid disposed in a borehole. In particular, the measuring is performed by fluorescence spectroscopy.

2. Description of the Related Art

Exploration and production of hydrocarbons generally require that a borehole be drilled into an earth formation that may contain a reservoir of the hydrocarbons. The borehole provides access to the earth formation for performing measurements related to a property of the formation or hydrocarbons contained therein.

In general, the earth formation may contain fluids that may seep into the borehole. At least one property of the fluids can then be measured and related to a property of the earth formation or the hydrocarbons contained in the earth formation. Fluorescence spectroscopy is one technique that can be used to measure a property of the fluids disposed within a borehole.

PCT application (International Publication Number WO 2005/17316) discloses a downhole fluorescence spectrometer for performing a spectrographic analysis of downhole fluids. The downhole fluorescence spectrometer “illuminates the fluid, which in turn fluoresces. The fluoresced light from the sample [of the fluid] is transmitted . . . towards an optical spectrum analyzer for analysis.”

The downhole fluorescence spectrometer disclosed in WO 2005/17316 “monitor[s] sample cleanup (change in fluorescence) as synthetic Oil Based Mud (OBM) filtrate has no aromatics so it does not fluoresce but crude oil has aromatics which do fluoresce.” In addition, this downhole fluorescence spectrometer “enables estimating additional crude oil properties downhole because a brighter and/or bluer measured fluorescence indicates a higher API (American Petroleum Institute) gravity. Upon depressurizing a live crude oil, the ratio of blue to green fluorescence changes upon passing below the asphaltene precipitation pressure.” Further, this downhole fluorescence spectrometer “provides fluorescent tracer applications in which adding a tracer to mud enables added enhanced measurements to distinguish between oil and OBM filtrate to help quantify OBM filtrate contamination based on the presence or absence of tracers.”

In apparatus for performing fluorescence spectroscopy, the fluorescent light emitted from a sample can be very weak. When the fluorescent light is very weak, devices that are highly sensitive to the fluorescent light are needed. The highly sensitive devices can add to the complexity and cost of the apparatus. In addition, an increase in the complexity may result in a decrease in reliability and accuracy.

Therefore, what are needed are techniques to increase the amount of fluorescent light emitted by a sample undergoing fluorescence spectroscopy.

### BRIEF SUMMARY OF THE INVENTION

Disclosed is a an apparatus for estimating a property of a fluid in an earth formation, the apparatus including: a logging instrument configured to be conveyed in a borehole penetrating the formation; and a plurality of light sources disposed at the logging instrument; wherein each of the light sources is configured to illuminate a sample of the fluid with a light beam causing the sample to fluoresce light with a characteristic related to the property, each of the light sources being configured to provide a light beam with a solid angle and a distance traveled to the sample, the solid angle and the distance being configured to concentrate the beam at an area of the sample that is overlapped substantially a same amount by a beam from another light source in the plurality.

Also disclosed is a method for estimating a property of a fluid in an earth formation, the method including: conveying a logging instrument in a borehole penetrating the formation, the logging instrument having a plurality of light sources configured to illuminate a sample of the fluid with light that causes the sample to fluoresce light, each of the light sources being configured to provide a light beam with a solid angle and a distance traveled to the sample, the solid angle and the distance being configured to concentrate the beam at an area of the sample that is overlapped substantially a same amount by a light beam from another light source in the plurality; illuminating the sample with light from the plurality of light sources; detecting light fluorescing from the sample; and estimating the property from the detected fluorescent light.

Further disclosed is a measurement cell for performing fluorescence spectroscopy on a sample of a material, the measurement cell including: a plurality of light sources configured to illuminate the sample with light that causes the sample to fluoresce light, each of the light sources being configured to provide a light beam with a solid angle and a distance traveled to the sample, the solid angle and the distance being configured to concentrate the beam at an area of the sample that is overlapped substantially a same amount by a light beam from another light source in the plurality.

### BRIEF DESCRIPTION OF THE DRAWINGS

The subject matter, which is regarded as the invention, is particularly pointed out and distinctly claimed in the claims at the conclusion of the specification. The foregoing and other features and advantages of the invention are apparent from the following detailed description taken in conjunction with the accompanying drawings, wherein like elements are numbered alike, in which:

FIG. 1 illustrates an exemplary embodiment of a logging instrument disposed in a borehole;

FIG. 2 depicts aspects of the logging instrument;

FIGS. 3A, 3B and 3C, collectively referred to herein as FIG. 3, depict aspects of a fluorescence spectroscopy unit;

FIG. 4 depicts aspects of a reflecting material used in a measuring cell;

FIG. 5 depicts aspects of light reflecting from the reflecting material;

FIG. 6 depicts aspects of a light coupler; and

FIG. 7 presents one example of a method for estimating a property of a fluid disposed in the borehole.

### DETAILED DESCRIPTION OF THE INVENTION

Disclosed are embodiments of techniques for increasing an amount of fluorescent light emitted by a sample undergoing fluorescence spectroscopy. The techniques, which include apparatus and method, call for increasing an amount of light illuminating the sample, thereby causing an increase in an amount of fluorescent light (i.e., the intensity of the fluorescent light) emitted by the sample.

The techniques increase the intensity of the emitted fluorescent light by illuminating the sample with light emitted from a plurality of light sources. The light sources are placed in an arrangement such that the light emitted from each light source combines with the light emitted from the other light sources to provide a total incident light with an intensity greater than the intensity of light emitted from a fewer number of light sources. The light from each light source is generally focused on a same area of the sample as light from other light sources in the plurality.

Certain definitions are provided for convenience. The term “fluorescence” relates to an optical phenomenon in which the molecular absorption of a photon by a cold body, such as a borehole fluid, triggers the emission of another photon with a longer wavelength. Usually the absorbed photon is in the ultraviolet range and the emitted light is in the visible range. The term “fluorescence spectroscopy” relates to a type of electromagnetic spectroscopy, which analyzes fluorescence from a sample of a material such as the borehole fluid. The terms “spectrometer” and “fluorometer” relate to a device for measuring parameters of fluorescent light such as its intensity and wavelength distribution of emission spectrum after excitation of a sample of material by a certain spectrum of light. These parameters are used to identify the presence and the amount of specific molecules in the sample (i.e., a property of the sample). The term “enhanced heat transfer capability” relates to material and structure specifically configured to transfer heat as opposed to components that may have some ancillary heat transfer capability such as electrical connections.

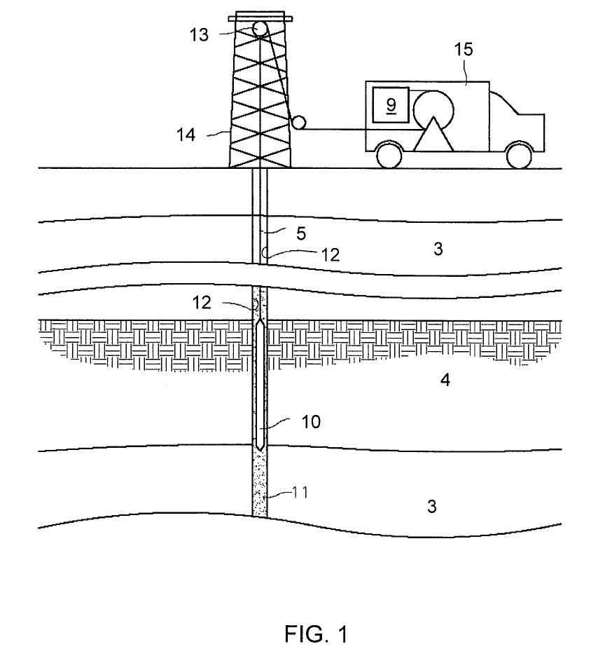

Referring to FIG. 1, a well logging instrument 10 is shown disposed in a borehole 2. The borehole 2 is drilled through earth 3 and penetrates a formation 4. In the embodiment of FIG. 1, the logging instrument 10 is lowered into and withdrawn from the borehole 2 by use of an armored electrical cable (known as a wireline) 5 or similar conveyance as is known in the art. Non-limiting examples of other conveyances include slickline and coiled tubing. The wireline 5 is often carried over a pulley 13 supported by a derrick 14. Wireline deployment and retrieval is generally performed by a powered winch carried by a service truck 15. In other embodiments, the logging instrument 10 may perform measurements, referred to as logging-while-drilling (LWD), during a temporary halt in drilling.

The logging instrument 10 as shown in FIG. 1 is configured to perform fluorescence spectroscopy on a formation fluid 6, located in the formation 4. The formation fluid 6 is removed from the formation 4 by a downhole sample extraction tool included with the logging instrument 10. Once the formation fluid 6 is removed from the formation 4, the fluid 6 may be referred to as a filtrate because the formation 4 acts as a filter. One non-limiting example of the filtrate is an Oil Based Mud (OBM) filtrate.

Referring to FIG. 1, the logging instrument 10 includes a fluorescence spectroscopy unit 7 for performing the fluorescence spectroscopy on the formation fluid 6. In the embodiment of FIG. 1, the logging instrument 10 includes an electronic unit 8 coupled to the fluorescence spectroscopy unit 7. The electronic unit 8 can be configured to transmit data from the fluorescence spectroscopy unit 7 to a processing system 9 located at the service truck 15 using the electrical cable 5. In LWD applications, the electronic unit 8 at least one of stores and processes the data.

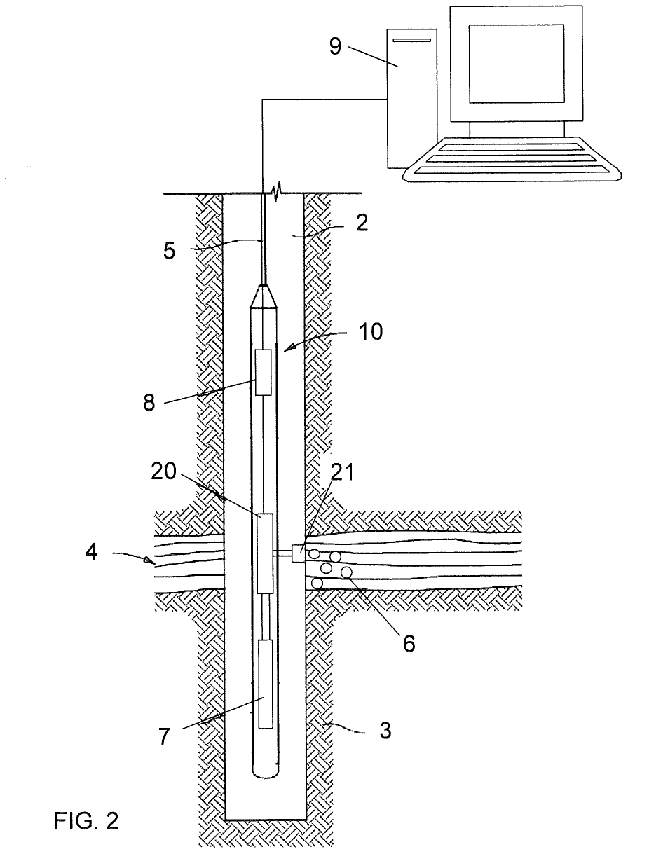

FIG. 2 depicts aspects of the logging instrument 10. Referring to FIG. 2, the logging instrument 10 includes a sample extraction tool 20. The sample extraction tool 20 is configured to extend and form an enclosed volume 21 about a portion of a wall of the borehole 2. By reducing pressure inside the volume 21, a sample of the formation fluid 6 can be extracted into the volume 21. In one embodiment, the sample is then transferred to the fluorescence spectroscopy unit 7 for analysis.

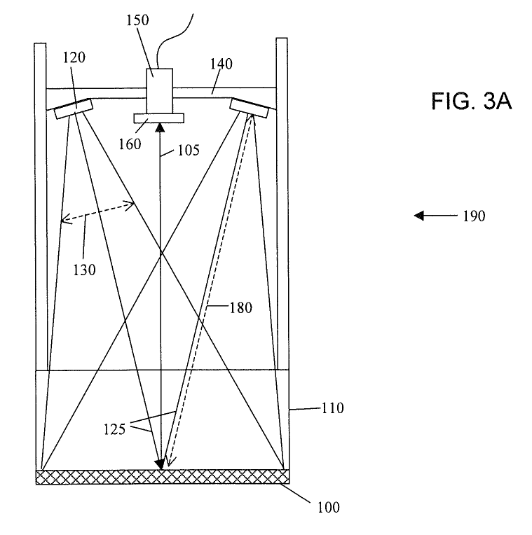

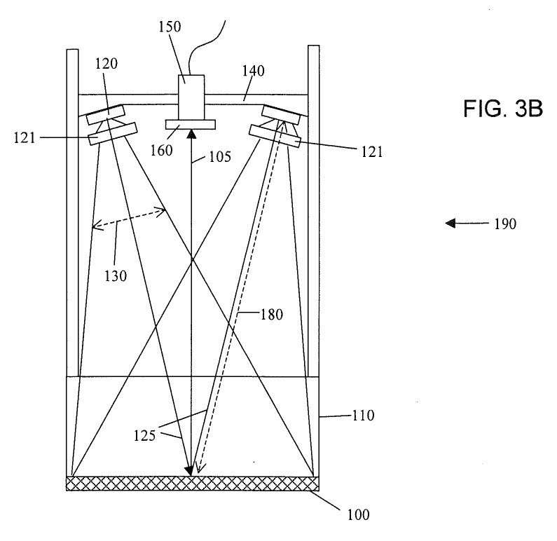

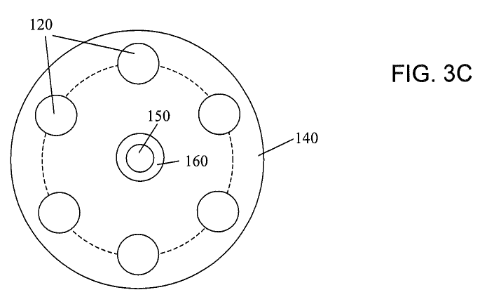

FIG. 3 illustrates aspects of the fluorescence spectroscopy unit 7. Referring to FIG. 3A, the fluorescence spectroscopy unit 7 includes a measurement cell 190 that contains a plurality of light sources 120 and at least one light detector 150. In the embodiment of FIG. 3A, the plurality of light sources 120 and the at least one light detector 150 are mounted on a bracket 140. The fluorescence spectroscopy unit 7 also includes a sapphire window 110, which makes contact with a sample 100 of the formation fluid 6. The sapphire window 110 isolates internal components of the measuring cell 190 from the fluid sample 100 while allowing light from the plurality of light sources 120 to illuminate the sample 100 with the incident light 125. In addition, the sapphire window 110 allows fluorescent light 105 emitted from the sample 100 to enter the measuring cell 190 and be measured by the at least one light detector 150.

The at least one light detector 150 detects the light fluoresced (i.e., the fluorescent light 105) from the sample 100 as a result of the illumination of the sample 100 by the light emitted by the plurality of light sources 120 (i.e., the incident light 125). Output from the at least one light detector 150 is, in general, processed by a spectrometer or a fluorometer. Output from the light detector 150 can also be sent to the processing system 9 for processing, recording or analysis.

In the embodiment of FIG. 3A, each light source 120 is directed or aimed such that a solid angle 130 of a beam formed by the incident light 125 combined with a distance 180 (from the light source 120 to an edge of the sample 100) covers substantially an entire visible area of the sample 100 exposed through the sapphire window 110. The solid angle 130 and the distance 180 are generally selected such that a well-defined energy (e.g., 50% of the whole transmitted energy) covers the entire visible area. In one embodiment, lenses 121 in optical communication with the light sources 120 may be used to establish the solid angle 130 as shown in FIG. 3B.

Because each of the light sources 120 generally emits light in the ultraviolet (UV) region of the light spectrum, a UV filter may be placed in a light inlet path to the light detector 150. Referring to FIG. 3A, a UV filter 160 is shown disposed in front of the light detector 150. The UV filter 160 blocks UV light emitted from the plurality of light sources 120 from entering the light detector 150 while allowing the fluorescent light emitted by the sample 100 to enter the light detector 150. In general, the fluorescent light is not in the UV region that is blocked by the UV filter 160. Thus, the light detector 150 will detect mainly the light fluoresced by the sample 100 for increased accuracy.

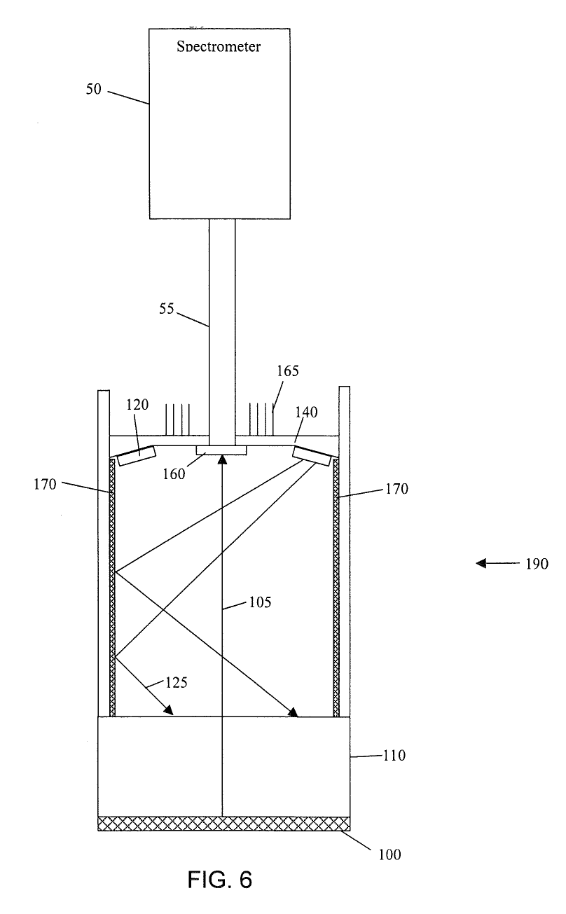

FIG. 3C illustrates a top view of the bracket 140. Referring to FIG. 3C, the plurality of light sources 120 is disposed in a circular arrangement (i.e., the center of each light source 120 is disposed on a circle and is equidistant from adjacent light sources 120). Because each of the light sources 120 emits a certain amount of heat energy, the teachings disclose including a heat transfer capability in the bracket 140. The heat transfer capability can protect the plurality of light sources 150 from thermal overload. One example of a technique to provide the heat transfer capability is to fabricate the bracket 160 from a metal with a high heat transfer capability such as copper. In addition, the bracket 160 can include fins 165 (shown in FIG. 6) to further increase the heat transfer capability.

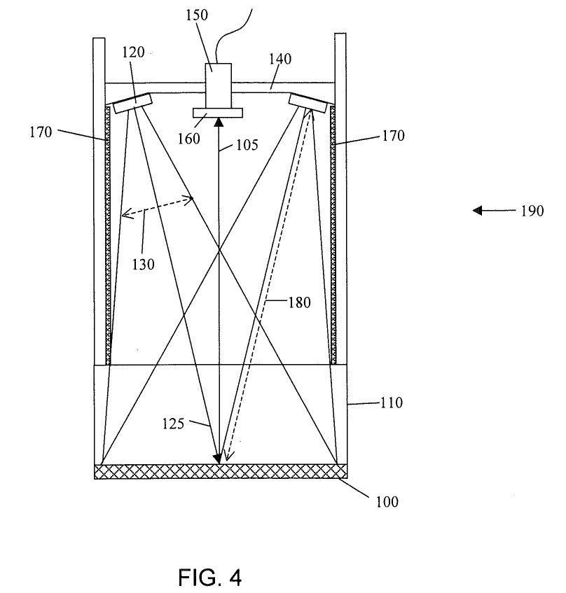

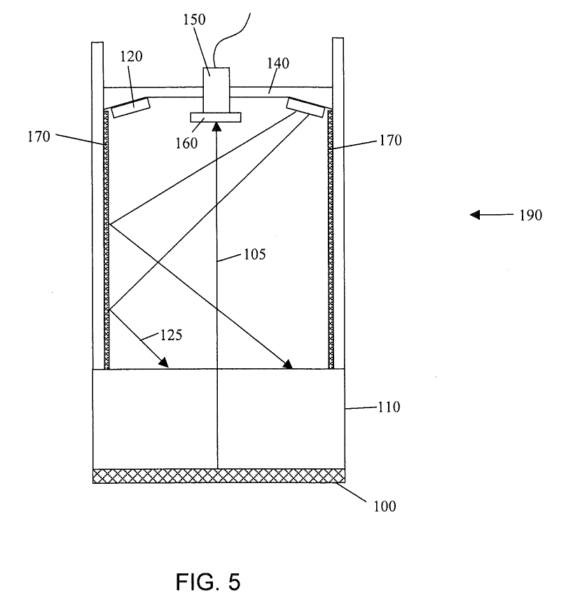

A certain amount of light may be emitted by each light source 120 outside of the solid angle 130. To increase the efficiency of the light emitted from each of the light sources 120, the teachings disclose coating an inner surface of the measurement cell 190 with a reflecting material 170 as shown in FIG. 4. FIG. 4 depicts light emitted from one light source 120 outside the solid angle 130 being reflected toward the sample 100.

In general, the reflecting material 170 is selected to have a maximal reflectance of light in the range of wavelengths of the light emitted from the plurality of light sources 120 (generally in the UV range). In addition, the reflecting material 170 is selected so as not to have any fluorescence properties of its own. Exemplary embodiments of the reflecting material 170 include gold and Spectralon®. Spectralon is a thermoplastic that can be machined to conform to a shape of the interior of the measurement cell 190. Spectralon has a very high reflectance over the UV-VIS-NIR region of the light spectrum. Spectralon is available from Labsphere® of North Sutton, N.H.

Each of the high sources 120 can be implemented by at least one of a light emitting diode (LED), a laser, and a lamp such as a xenon arc lamp and a mercury vapor lamp. In general, each of the light sources 120 is configured to emit light in the UV region at a wavelength suitable for fluorescence spectrospcopy.

The light detector 150 can be implemented with a light detecting device configured to detect light with a wavelength in a range that includes the fluoresced light from the sample 100. Non-limiting examples of the light detector 150 include a photodiode, a photoresistor, a phototransistor, a photovoltaic cell, a photographic plate, and a charged-coupled device. In one embodiment, the light detector 150 can be disposed remote to the measuring cell 190. Referring to FIG. 6, the light detector 150 can be incorporated into a spectrometer 50 (or fluorometer 50). In the embodiment of FIG. 6, a light coupler 55 is used to transmit the fluorescent light 105 emitted by the sample 100 to the spectrometer 50 for measurement and analysis. Non-limiting examples of the light coupler 55 include a fiber optic, lens optics, and free ray optics.

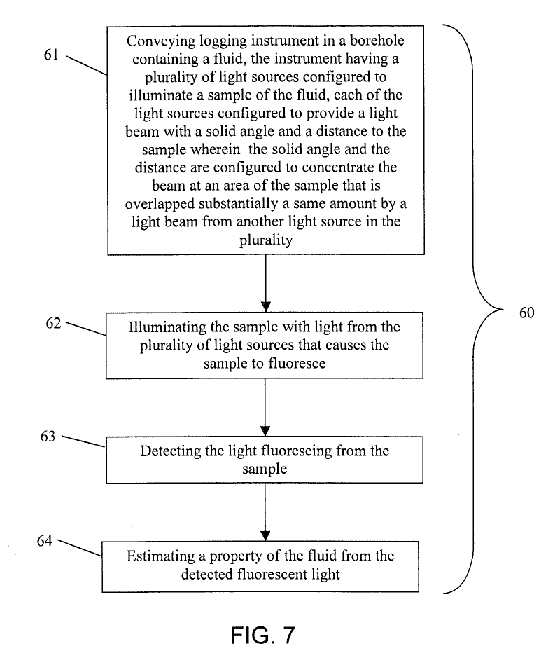

FIG. 7 presents one example of a method 60 for estimating a property of the fluid 6 disposed in the borehole 2. The method 60 calls for (step 61) conveying the logging instrument 10 in the borehole 2. The logging instrument 10 has a plurality of light sources 120 illuminating the sample 100 of the fluid 6 with the incident light 125 that causes the sample 100 to fluoresce light. Each of the light sources 120 is configured to provide a light beam with the solid angle 130 and the distance 180 traveled to the sample 100. The solid angle 130 and the distance 180 are configured to concentrate the beam at an area of the sample 100 that is overlapped substantially a same amount by a beam from another light source 120 in the plurality of light sources 120. Further, the method 60 calls for (step 62) illuminating the sample 100 with the incident light 125 emitted from the plurality of light sources 120. Further, the method 60 calls for (step 63) detecting the fluorescent light 105 emitted by the sample 100. Further, the method 60 calls for (step 64) estimating the property from the detected fluorescent light.

In support of the teachings herein, various analysis components may be used, including a digital and/or an analog system. For example, the electronic unit 8, the processing system 9, and the spectrometer/fluorometer 50 can include the digital and/or analog system. The digital and/or analog system may have components such as a processor, storage media, memory, input, output, communications link (wired, wireless, pulsed mud, optical or other), user interfaces, software programs, signal processors (digital or analog) and other such components (such as resistors, capacitors, inductors and others) to provide for operation and analyses of the apparatus and methods disclosed herein in any of several manners well-appreciated in the art. It is considered that these teachings may be, but need not be, implemented in conjunction with a set of computer executable instructions stored on a computer readable medium, including memory (ROMs, RAMs), optical (CD-ROMs), or magnetic (disks, hard drives), or any other type that when executed causes a computer to implement the method of the present invention. These instructions may provide for equipment operation, control, data collection and analysis and other functions deemed relevant by a system designer, owner, user or other such personnel, in addition to the functions described in this disclosure.

Further, various other components may be included and called upon for providing for aspects of the teachings herein. For example, a sample line, sample storage, sample chamber, sample exhaust, pump, piston (for pressurizing and depressurizing the sample 100 as one example), power supply (e.g., at least one of a generator, a remote supply and a battery), vacuum supply, pressure supply, cooling unit, heating unit, motive force (such as a translational force, propulsional force or a rotational force), magnet, electromagnet, sensor, electrode, transmitter, receiver, transceiver, antenna, controller, optical unit, electrical unit or electromechanical unit may be included in support of the various aspects discussed herein or in support of other functions beyond this disclosure.

Elements of the embodiments have been introduced with either the articles “a” or “an.” The articles are intended to mean that there are one or more of the elements. The terms “including” and “having” and their derivatives are intended to be inclusive such that there may be additional elements other than the elements listed. The conjunction “or” when used with a list of at least two terms is intended to mean any term or combination of terms.

It will be recognized that the various components or technologies may provide certain necessary or beneficial functionality or features. Accordingly, these functions and features as may be needed in support of the appended claims and variations thereof, are recognized as being inherently included as a part of the teachings herein and a part of the invention disclosed.

While the invention has been described with reference to exemplary embodiments, it will be understood that various changes may be made and equivalents may be substituted for elements thereof without departing from the scope of the invention. In addition, many modifications will be appreciated to adapt a particular instrument, situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. An apparatus for estimating a property of a fluid in an earth formation, the apparatus comprising:
a logging instrument configured to be conveyed in a borehole penetrating the formation; and
a plurality of light sources disposed at the logging instrument;
wherein each of the light sources is configured to illuminate a sample of the fluid with a light beam causing the sample to fluoresce light with a characteristic related to the property, each of the light sources being configured to provide a light beam with a solid angle and a distance traveled to the sample, the solid angle and the distance configured to concentrate the beam at an area of the sample that is overlapped substantially a same amount by a light beam from another light source in the plurality.

2. The apparatus of claim 1, wherein each of the light sources is disposed at a bracket.

3. The apparatus of claim 2, wherein the bracket comprises an enhanced heat transfer capability.

4. The apparatus of claim 3, wherein the bracket comprises a material having enhanced heat transfer capability.

5. The apparatus of claim 4, wherein the material comprises a metal.

6. The apparatus of claim 3, wherein the bracket comprises fins for heat dissipation.

7. The apparatus of claim 1, wherein the plurality of light sources is disposed in a circular arrangement.

8. The apparatus of claim 7, further comprising at least a portion of a light detection device disposed at a center of the circular arrangement.

9. The apparatus of claim 8, wherein the light detection device comprises at least one of a photodiode, a photomultiplier tube, a photoresistor, a phototransistor, a photovoltaic cell, and a charged-coupled device.

10. The apparatus of claim 8, wherein the light detection device comprises at least one of a fiber optic, lens optics, and free ray optics disposed at the center of the circular arrangement and coupled to at least one of a spectrometer and a fluorometer.

11. The apparatus of claim 1, wherein the plurality of light sources is disposed within a measurement cell, the measurement cell comprising an interior lined with a light reflecting material.

12. The apparatus of claim 11, wherein the light reflecting material comprises gold.

13. The apparatus of claim 11, wherein the light reflecting material comprises Spectralon®.

14. The apparatus of claim 1, wherein the plurality of light sources emits ultraviolet (UV) light.

15. The apparatus of claim 14, wherein at least one light source comprises a light emitting diode (LED).

16. The apparatus of claim 1, wherein the area of the sample comprises substantially the entire area of the sample visible to the plurality of light sources.

17. A method for estimating a property of a fluid in an earth formation, the method comprising:
conveying a logging instrument in a borehole penetrating the formation, the logging instrument comprising a plurality of light sources configured to illuminate a sample of the fluid with light that causes the sample to fluoresce light, each of the light sources being configured to provide a light beam with a solid angle and a distance traveled to the sample, the solid angle and the distance being configured to concentrate the beam at an area of the sample that is overlapped substantially a same amount by a light beam from another light source in the plurality;
illuminating the sample with light from the plurality of light sources;
detecting light fluorescing from the sample; and
estimating the property from the detected fluorescent light.

18. The method of claim 17, further comprising dissipating heat from the plurality of light sources with a bracket connected to the plurality of light sources.

19. The method of claim 17, further comprising reflecting the light emitted from the plurality of light sources with a reflecting material lining an interior surface of a measurement cell, the reflected light being directed towards the sample.

20. A measurement cell for performing fluorescence spectroscopy on a sample of a material, the measurement cell comprising:
a plurality of light sources configured to illuminate the sample with light causing the sample to fluoresce light, each of the light sources being configured to provide a light beam with a solid angle and a distance traveled to the sample, the solid angle and the distance being configured to concentrate the beam at an area of the sample that is overlapped substantially a same amount by a light beam from another light source in the plurality.

21. The measurement cell of claim 20, wherein the plurality of light sources is disposed in a circular arrangement.

22. The measurement cell of claim 21, wherein a light detection device is disposed within the circular arrangement.
